(19) United States
(12) Patent Application Publication
(10) Pub. No.: US 2013/0109381 A1
(43) Pub. Date: May 2, 2013

(54) MOBILE COMMUNICATION SYSTEM, RADIO ACCESS NETWORK APPARATUS, AND MOBILE STATION

(71) Applicants: Hideaki Takahashi, Chiyoda-ku (JP); Yuichiro Nakamura, Chiyoda-ku (JP); Kenichiro Aoyagi, Chiyoda-ku (JP); Tadashi Uchiyama, Chiyoda-ku (JP); Minami Ishii, Chiyoda-ku (JP)

(72) Inventors: Hideaki Takahashi, Chiyoda-ku (JP); Yuichiro Nakamura, Chiyoda-ku (JP); Kenichiro Aoyagi, Chiyoda-ku (JP); Tadashi Uchiyama, Chiyoda-ku (JP); Minami Ishii, Chiyoda-ku (JP)

(21) Appl. No.: 13/261,496

(22) PCT Filed: Apr. 28, 2011
(86) PCT No.: PCT/JP11/60382

§ 371 Date: Jan. 15, 2013

(30) Foreign Application Priority Data
Apr. 30, 2010 (JP) 2010-105886

(51) Int. Cl. H04W 48/12

(52) U.S. Cl. CPC H04W 48/12
USPC 455/435.1

(57) ABSTRACT

Provided is a mobile communication system wherein a radio base station eNB in E-UTRAN is configured to transmit a downlink carrier frequency (EARFCN) and a physical cell ID (PCI) of a blacklisted cell, which is a cell to which access is forbidden in the downlink carrier frequency, to a radio network controller RNC in UTRAN.

### TECHNICAL FIELD

The present invention relates to a mobile communication system, a radio access network apparatus, and a mobile station.

### BACKGROUND ART

3GPP discusses, as a function of “SON (Self Configuration and Self Organization)”, to exchange load information (Resource Status) in each cell between different types of RAT (Radio Access Technology).

For example, it is discussed to exchange load information in each cell between E-UTRAN (Evolved Universal Terrestrial Radio Access Network) and UTRAN (Universal Terrestrial Radio Access Network).

Furthermore, in order to perform load distribution, it is possible for a radio base station eNB (or a radio network controller RNC in the UTRAN) in the E-UTRAN to allow a mobile station UE in a cell subordinate to the radio base station eNB to be transited to a UTRAN cell (or an E-UTRAN cell) on the basis of the load information.

Furthermore, in the aforementioned mobile communication system, when transition of the mobile station UE to the E-UTRAN was instructed by the radio network controller RNC, the mobile station UE is configured to select a cell with the best radio quality in a frequency designated by the radio network controller RNC, and to acquire broadcast information in the selected cell.

It is possible for the radio network controller RNC to also instruct a blacklisted cell, to which access is forbidden in the frequency, to the mobile station UE.

However, the blacklisted cell corresponds to information managed by the E-UTRAN, and thus there is a problem that the blacklisted cell should be set in the radio network controller RNC by using a network management system (O&M: Operation and Management system) used by a communication provider, or in a static manner.

Therefore, the present invention has been achieved in view of the above-described problems, and an object thereof is to provide, in a radio network controller RNC, a mobile communication system, a radio access network apparatus, and a mobile station, by which it is possible to acquire a blacklisted cell managed by E-UTRAN by using a method conforming to the function (TS25.413, TS36.413, TS48.018 and the like) defined in 3GPP specifications.

### SUMMARY OF THE INVENTION

A first characteristic of the present embodiment is summarized in that a mobile communication system includes: a first radio access network; and a second radio access network, wherein a radio access network apparatus in the first radio access network is configured to transmit a downlink carrier frequency and a physical cell ID of a blacklisted cell, which is a cell to which access is forbidden in the downlink carrier frequency, to a radio access network apparatus in the second radio access network.

A second characteristic of the present embodiment is summarized in that a radio access network apparatus in a first radio access network is configured to transmit a downlink carrier frequency and a physical cell ID of a blacklisted cell, which is a cell to which access is forbidden in the downlink carrier frequency, to a radio access network apparatus in a second radio access network.

A third characteristic of the present embodiment is summarized in that a mobile station, which is used in a mobile communication system including a first radio access network and a second radio access network, includes: a reception unit configured to receive an instruction signal that instructs transition to a cell in the first radio access network from a radio access network apparatus in the second radio access network; and a cell selection unit configured not to select a blacklisted cell designated by a physical cell ID included in the received instruction signal, in a downlink carrier frequency which is included in the instruction signal.

As described above, according to the present invention, it is possible to provide in a radio network controller RNC, a mobile communication system, a radio access network apparatus, and a mobile station, by. which it is possible to acquire a blacklisted cell managed by E-UTRAN by using a method conforming to the function (TS25.413, TS36.413, TS48.018 and the like) defined in 3GPP specifications at the same time when a radio network controller RNC instructs a mobile station UE to perform transition to the E-UTRAN.

### BRIEF DESCRIPTION OF DRAWINGS

FIG. 1 is a diagram showing the entire configuration of a mobile communication system according to a first embodiment of the present invention.

FIG. 2 is a diagram showing a protocol stack of the mobile communication system according to the first embodiment of the present invention.

FIG. 3 is a sequence diagram illustrating an operation of the mobile communication system according to the first embodiment of the present invention.

FIG. 4 is a functional block diagram of a mobile station according to the first embodiment of the present invention.

FIG. 5 is a sequence diagram illustrating an operation of the mobile communication system according to the first embodiment of the present invention.

FIG. 6 is a flowchart illustrating an operation of the mobile station according to the first embodiment of the present invention.

### DESCRIPTION OF EMBODIMENTS

### (Mobile Communication System According to First Embodiment of the Present Invention)

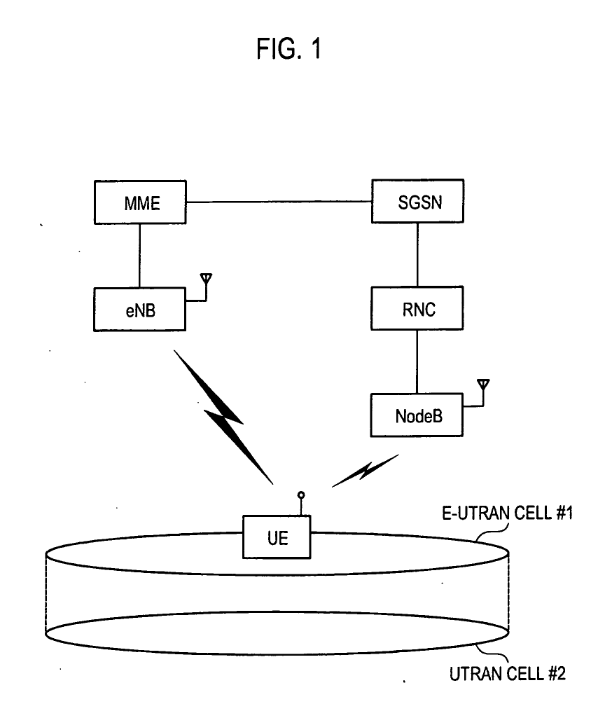

With reference to FIG. 1 to FIG. 5, the configuration of a mobile communication system according to a first embodiment of the present invention will be described.

As illustrated in FIG. 1, the mobile communication system according to the present embodiment includes E-UTRAN, a mobile network that accommodates the E-UTRAN, UTRAN, and a core network that accommodates the UTRAN.

A radio base station eNB is located in the E-UTRAN, a mobile management node MME is located in the mobile network, a radio base station NodeB and a radio network controller RNC are located in the UTRAN, and a packet switch SGSN is located in the core network.

In the example of FIG. 1, an E-UTRAN cell #1 subordinate to the radio base station eNB and a UTRAN cell #2 subordinate to the radio base station NodeB (the radio network controller RNC) are located to be geographically superposed.

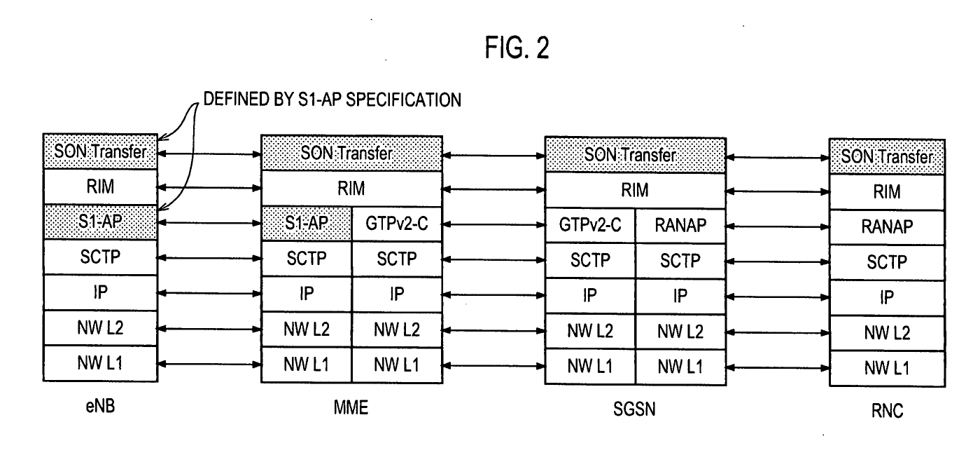

FIG. 2 is a diagram showing a protocol stack of the mobile communication system according to the present embodiment.

As illustrated in FIG. 2, as protocol functions, the radio base station eNB includes a NWL1 (Network Layer 1) function, a NWL2 (Network Layer 2) function, an IP (Internet Protocol) layer function, a SCTP (Stream Control Transmission Protocol) layer function, an S1-AP (S1 Application) layer function, a RIM (RAN Information Transfer) layer function, and an SON Transfer layer function.

Furthermore, as protocol functions, the mobile management node MME includes a NWL1 function, a NWL2 function, an IP layer function, a SCTP layer function, and an S1-AP layer function to a side of the radio base station eNB, includes a NWL1 function, a NWL2 function, an IP layer function, a SCTP layer function, and a GTP (GPRS Tunneling Protocol) v2-C layer function to a side of the packet switch SGSN, and further includes a RIM layer function and an SON Transfer layer function.

Furthermore, as protocol functions, the packet switch SGSN includes a NWL1 function, a NWL2 function, an IP layer function, a SCTP layer function, and a GTPv2-C layer function to a side of the mobile management node MME, includes a NWL1 function, a NWL2 function, an IP layer function, a SCTP layer function, and a RANAP (Radio Access Network Application Part) layer function to a side of the radio network controller RNC, and further includes a RIM layer function and an SON Transfer layer function.

Moreover, as protocol functions, the radio network controller RNC includes a NWL1 function, a NWL2 function, an IP layer function, a SCTP layer function, a RANAP layer function, a RIM layer function, and an SON Transfer layer function.

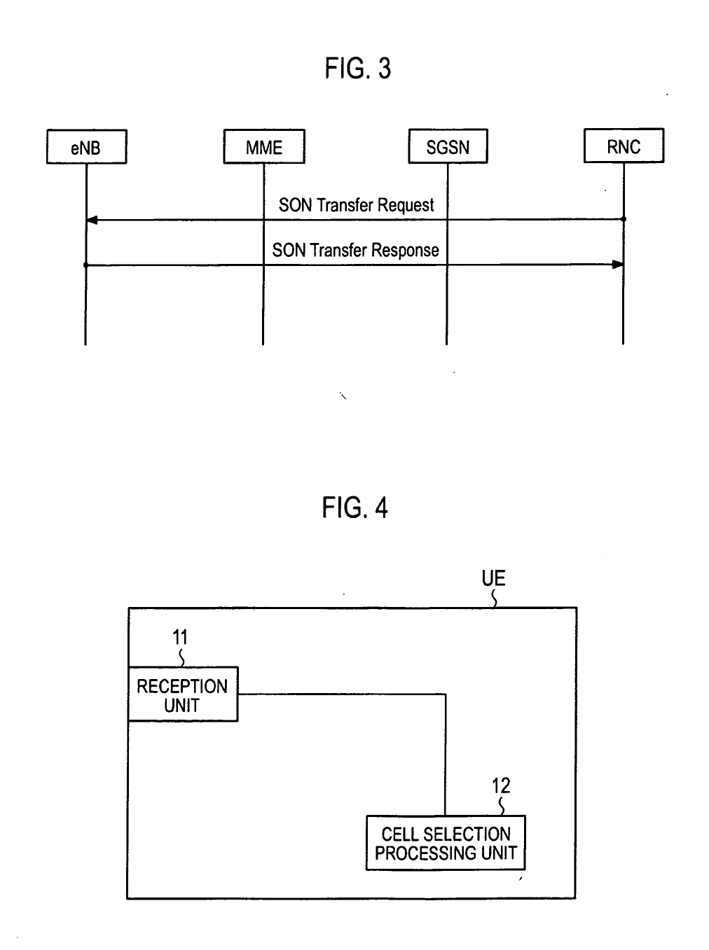

As illustrated in FIG. 3, as defined in TS36.413 of 3GPP, when “SON Transfer Request” is received from the radio network controller RNC, the radio base station eNB is configured to transmit “SON Transfer Response” to the radio network controller RNC.

Furthermore, the radio base station eNB is configured to transmit a downlink carrier frequency (DL Carrier Frequency, EARFCN: E-UTRA Absolute Radio Frequency Channel Number) and a physical cell ID (PCI: Physical Cell ID) of a blacklisted cell, which is a cell to which access is forbidden in the downlink carrier frequency, to the radio network controller RNC through the “SON Transfer Response”.

In addition, when a plurality of downlink carriers are used in the E-UTRAN, the “SON Transfer Request” and the “SON Transfer Response” are configured to be exchanged between the radio base station eNB and the radio network controller RNC by the number of downlink carriers used.

As illustrated in FIG. 4, a mobile station UE includes a reception unit 11 and a cell selection processing unit 12.

The reception unit 11 is configured to receive an instruction signal that instructs transition to an E-UTRAN cell from the radio network controller RNC in the UTRAN when the mobile station UE camps in the UTRAN.

For example, the reception unit 11 is configured to receive, as the instruction signal, a signal “RRC Connection Release” for requesting the release of an RRC connection established by the mobile station UE in the UTRAN, a signal “RRC Connection Reject” for rejecting “RRC Connection Request” transmitted from the mobile station UE to the UTRAN, and the like.

In addition, the reception unit 11 may be configured to receive an instruction signal that instructs transition to a UTRAN cell from the radio base station eNB in the E-UTRAN when the mobile station UE camps in the E-UTRAN.

The cell selection processing unit 12 is configured to perform transition to the E-UTRAN (or the UTRAN) in response to the instruction signal received in the reception unit 11, and to select a cell with the best radio quality in a downlink carrier frequency included in the instruction signal.

Furthermore, the cell selection processing unit 12 is configured not to select a blacklisted cell designated by a physical cell ID included in the received instruction signal, in the downlink carrier frequency included in the instruction signal.

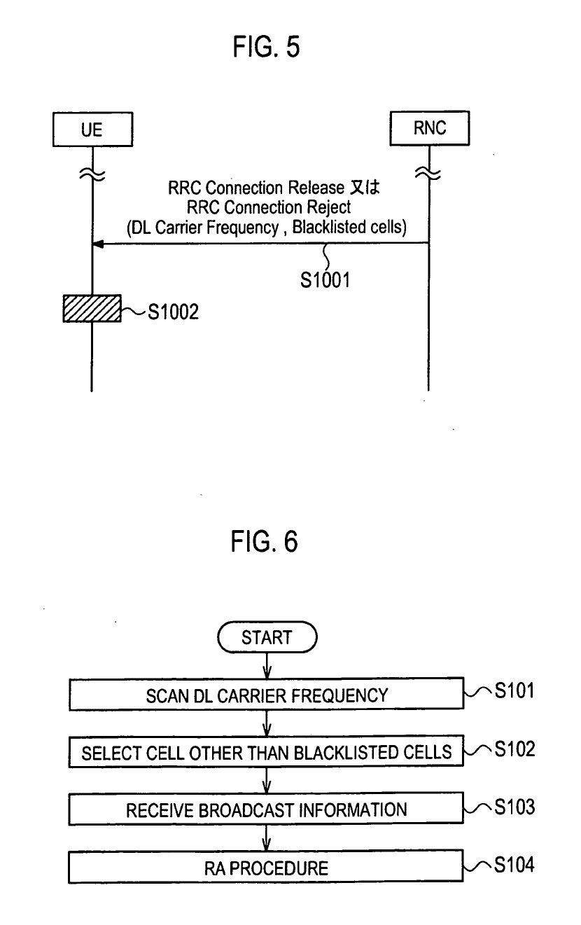

Hereinafter, with reference to FIG. 5 and FIG. 6, a description will be provided for an operation in which the mobile station UE is transitioned from the UTRAN to the E-UTRAN in the mobile communication system according to the present embodiment.

As illustrated in FIG. 5, in step S1001, the radio network controller RNC transmits “RRC Connection Release” or “RRC Connection Reject”, which includes “DL Carrier Frequency (EARFCN)” and “Blacklisted cells (PCI)”, to the mobile station UE.

In step S1002, the mobile station UE performs an operation illustrated in FIG. 6.

Specifically, as illustrated in FIG. 6, the mobile station UE scans the “DL Carrier Frequency (EARFCN)” in step S101 and selects a cell with the best radio quality, other than a cell designated by the “Blacklisted cells (PCI)”, from scanned cells in step S102.

In step S103, the mobile station UE receives broadcast information in the selected cell, for example, MIB (Master Information Block) or SIB (System Information Block).

Furthermore, based on barring information in the received broadcast information, when it is determined that access in the selected cell is barred, the mobile station UE returns to the step S102 and attempts to select another cell.

Based on the barring information in the received broadcast information, when it is determined that access in the selected cell is not barred, the mobile station UE starts a RA (Random Access) procedure in the cell in step S104.

In accordance with the mobile communication system according to the present invention, it is possible for the mobile station UE to comprehend a blacklisted cell in a frequency of a transition destination by an instruction signal from the radio network controller RNC (or the radio base station eNB), and thus it is possible to avoid the selection of the blacklisted cell in the frequency of the transition destination, thereby quickly completing transition to the E-UTRAN (or the UTRAN).

The characteristics of the present embodiment as described above may be expressed as follows.

A first characteristic of the present embodiment is summarized in that a mobile communication system includes: E-UTRAN (a first radio access network); and UTRAN (a second radio access network), wherein a radio base station eNB (a radio access network apparatus in the first radio access network) in the E-UTRAN is configured to transmit a downlink carrier frequency (EARFCN) and a physical cell ID (PCI) of a blacklisted cell, which is a cell to which access is forbidden in the downlink carrier frequency, to a radio network controller RNC (a radio access network apparatus in the second radio access network) in the UTRAN.

In the first characteristic of the present embodiment, the radio network controller RNC may be configured to notify a mobile station UE of the downlink carrier frequency and the physical cell ID of the blacklisted cell in the downlink carrier through an instruction signal that instructs transition to an E-UTRAN cell (a cell in the first radio access network), and the mobile station UE may be configured not to select a blacklisted cell designated by the physical cell ID in the downlink carrier frequency.

A second characteristic of the present embodiment is summarized in that a radio base station eNB in E-UTRAN is configured to transmit a downlink carrier frequency and a physical cell ID of a blacklisted cell, which is a cell to which access is forbidden in the downlink carrier frequency, to a radio network controller RNC in UTRAN.

A third characteristic of the present embodiment is summarized in that a mobile station UE, which is used in a mobile communication system including E-UTRAN and UTRAN, includes: a reception unit 11 configured to receive an instruction signal that instructs transition to an E-UTRAN cell from the radio network controller RNC in the UTRAN; and a cell selection unit 12 configured not to select a blacklisted cell designated by a physical cell ID included in the received instruction signal, in a downlink carrier frequency included in the instruction signal.

In the first and third characteristics of the present embodiment, the instruction signal may include a signal “RRC Connection Release” for requesting the release of an RRC connection established by the mobile station UE in the UTRAN.

In the first and third characteristics of the present embodiment, the instruction signal may include a signal “RRC Connection Reject” for rejecting “RRC Connection Request (a connection setting request)” transmitted from the mobile station UE to the UTRAN.

In addition, the operation of the mobile station UE, the radio base station eNB/NodeB, the radio network controller RNC, the mobile management node MME, or the packet switch SGSN may be performed by hardware, a software module performed by a processor, or a combination of the both.

The software module may be arranged in a storage medium of an arbitrary format such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to the processor so that the processor can write and read information into and from the storage medium. Such a storage medium may also be accumulated in the processor. Such a storage medium and processor may be arranged in an ASIC. The ASIC may be arranged in the mobile station UE, the radio base station eNB/NodeB, the radio network controller RNC, the mobile management node MME, or the packet switch SGSN. Furthermore, the storage medium and the processor may be arranged, as a discrete component, in the mobile station UE, the radio base station eNB/NodeB, the radio network controller RNC, the mobile management node MME, or the packet switch SGSN.

Thus, the present invention has been explained in detail by using the above-described embodiments; however, it is obvious that for persons skilled in the art, the present invention is not limited to the embodiments explained herein. The present invention can be implemented as a corrected and modified mode without departing the gist and the scope of the present invention defined by the claims. Therefore, the description of the specification is intended for explaining the example only and does not impose any limited meaning to the present invention.

### Industrial Applicability

As described above, according to the present invention, it is possible to provide in a radio network controller RNC, a mobile communication system, a radio access network apparatus, and a mobile station, by which it is possible to acquire a blacklisted cell managed by E-UTRAN by using a method conforming to the function (TS25.413, TS36.413, TS48.018 and the like) defined in 3GPP specifications at the same time when a radio network controller RNC instructs a mobile station UE to perform transition to the E-UTRAN.

### [Reference Signs List]

UE . . . Mobile station

11 . . . Reception unit

12 . . . Cell selection unit

eNB, NodeB . . . Radio base station

RNC . . . Radio network controller

MME . . . Mobile management node

SGSN . . . Packet switch

1. A mobile communication system comprising:
a first radio access network; and
a second radio access network, wherein
a radio access network apparatus in the first radio access network is configured to transmit a downlink carrier frequency and a physical cell ID of a blacklisted cell, which is a cell to which access is forbidden in the downlink carrier frequency, to a radio access network apparatus in the second radio access network,
the radio access network apparatus in the second radio access network is configured to notify a mobile station of the downlink carrier frequency and the physical cell ID of the blacklisted cell in the downlink carrier through an instruction signal that instructs transition to a cell in the first radio access network,
the mobile station is configured not to select a blacklisted cell designated by the physical cell ID in the downlink carrier frequency, and
the instruction signal includes a signal for requesting release of a connection established by the mobile station in the second radio access network.

2.-5. (canceled)

6. A mobile station, which is used in a mobile communication system including a first radio access network and a second radio access network, comprising:
a reception unit configured to receive an instruction signal that instructs transition to a cell in the first radio access network from a radio access network apparatus in the second radio access network; and
a cell selection unit configured not to select a blacklisted cell designated by a physical cell ID included in the received instruction signal, in a downlink carrier frequency which is included in the instruction signal, wherein
the instruction signal includes a signal for requesting release of a connection established by the mobile station in the second radio access network.

7.-8. (canceled)

9. A mobile communication system comprising: a first radio access network; and a second radio access network, wherein
a radio access network apparatus in the first radio access network is configured to transmit a downlink carrier frequency and a physical cell ID of a blacklisted cell, which is a cell to which access is forbidden in the downlink carrier frequency, to a radio access network apparatus in the second radio access network,
the radio access network apparatus in the second radio access network is configured to notify a mobile station of the downlink carrier frequency and the physical cell ID of the blacklisted cell in the downlink carrier through an instruction signal that instructs transition to a cell in the first radio access network,
the mobile station is configured not to select a blacklisted cell designated by the physical cell ID in the downlink carrier frequency, and
the instruction signal includes a signal for rejecting a connection setting request transmitted from the mobile station to the second radio access network.

10. A mobile station, which is used in a mobile communication system including a first radio access network and a second radio access network, comprising:
a reception unit configured to receive an instruction signal that instructs transition to a cell in the first radio access network from a radio access network apparatus in the second radio access network;
a cell selection unit configured not to select a blacklisted cell designated by a physical cell ID included in the received instruction signal, in a downlink carrier frequency which is included in the instruction signal, wherein
the instruction signal includes a signal for rejecting a connection setting request transmitted from the mobile station to the second radio access network.
